(19) United States
(12) Patent Application Publication
(10) Pub. No.: US 2025/0071684 A1
(43) Pub. Date: Feb. 27, 2025

(54) WAKE-UP SIGNAL TRANSMISSION METHOD AND APPARATUS, UE, NETWORK SIDE DEVICE, AND MEDIUM

(71) Applicant: VIVO MOBILE COMMUNICATION CO., LTD., Dongguan (CN)

(72) Inventors: Jianhui LI, Dongguan (CN); Gen LI, Dongguan (CN); Xiaodong YANG, Dongguan (CN)

(73) Assignee: VIVO MOBILE COMMUNICATION CO., LTD., Dongguan (CN)

(21) Appl. No.: 18/943,731

(22) Filed: Nov. 11, 2024

Related U.S. Application Data
(63) Continuation of application No. PCT/CN2023/092802, filed on May 8, 2023.

(30) Foreign Application Priority Data
May 10, 2022 (CN) 202210509543.0

(51) Int. Cl. H04W 52/02; H04W 36/00

(52) U.S. Cl. CPC H04W 52/0235; H04W 36/0085

(57) ABSTRACT

This application discloses a wake-up signal transmission method and apparatus, a UE, a network side device, and a medium. The wake-up signal transmission method of the application includes: obtaining, by user equipment (UE), a wake-up signal associated with a target cell; and sending, by the UE, the wake-up signal.

This application is a continuation of International Application No. PCT/CN 2023/092802, filed on May 8, 2023, which claims priority to Chinese Patent Application No. 2022105095430, filed on May 10, 2022. The entire contents of each of the above-referenced applications are expressly incorporated herein by reference.

### TECHNICAL FIELD

This application pertains to the field of communication technologies, and in particular, to a wake-up signal transmission method and apparatus, a UE, a network side device, and a medium.

### BACKGROUND

In energy consumption of uplink and downlink transmission of a base station, downlink transmission accounts for a large proportion. To reduce energy consumption of the base station, the base station usually saves energy by shutting down downlink transmission and increasing the transmission cycle of a common signal. When the base station enters this kind of energy-saving mode, the base station needs to be assisted by a network or a terminal to return to a normal working mode from the energy-saving mode in a timely manner.

In the related art, the terminal may broadcast a wake-up signal to switch the base station from the energy-saving mode to the normal working mode, thereby realizing data transmission with the terminal. However, when the terminal broadcasts the wake-up signal, a plurality of base stations may be switched from the energy-saving mode to the normal working mode, which leads to a certain waste of energy consumption.

### SUMMARY

Embodiments of this application provide a wake-up signal transmission method and apparatus, a UE, a network side device, and a medium.

According to a first aspect, a wake-up signal transmission method is provided, and the method includes: obtaining, by a UE, a wake-up signal associated with a target cell; and sending, by the UE, the wake-up signal.

According to a second aspect, a wake-up signal transmission apparatus is provided, and the apparatus includes: an obtaining module and a sending module. The obtaining module is configured to obtain a wake-up signal associated with a target cell. The sending module is configured to send the wake-up signal.

According to a third aspect, a wake-up signal transmission method is provided, and the method includes: receiving, by a network side device from a UE, a wake-up signal associated with a target cell; and waking up the target cell in a case that a cell corresponding to the network side device includes the target cell.

According to a fourth aspect, a wake-up signal transmission apparatus is provided, applied to a network side device, and the apparatus includes: a receiving module, configured to receive, from a UE, a wake-up signal associated with a target cell; and an execution module, configured to: in a case that a cell corresponding to the network side device includes the target cell, wake up the target cell received by the receiving module.

According to a fifth aspect, a UE is provided. The UE includes a processor and a memory, the memory stores a program or an instruction that can be run on the processor, and when the program or the instruction is executed by the processor, the steps of the method according to the first aspect are implemented.

According to a sixth aspect, a UE is provided, including a processor and a communication interface. The processor is configured to obtain a wake-up signal associated with a target cell, and the communication interface is configured to send the wake-up signal.

According to a seventh aspect, a network side device is provided. The network side device includes a processor and a memory, the memory stores a program or an instruction that can be run on the processor, and when the program or the instruction is executed by the processor, the steps of the method according to the third aspect are implemented.

According to an eighth aspect, a network side device is provided, including a processor and a communication interface, where the communication interface is configured to receive, from a UE, a wake-up signal associated with a target cell; and the processor is configured to: in a case that a cell corresponding to the network side device includes the target cell, wake up the target cell received by the receiving module.

According to a ninth aspect, a communication system is provided, including a UE and a network side device. The UE may be configured to perform the steps of the method according to the first aspect, and the network side device may be configured to perform the steps of the method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the steps of the method according to the first aspect or the third aspect.

According to a twelfth aspect, a computer program/program product is provided, where the computer program/program product is stored in a storage medium, and the computer program/program product is executed by at least one processor to implement the steps of the method according to the first aspect or the third aspect.

In the embodiments of this application, the UE may obtain a wake-up signal associated with a target cell, and then send the wake-up signal to wake up the target cell. In this way, by determining the wake-up signal associated with the target cell in advance, the UE may wake up only the target cell associated with the wake-up signal after sending out the wake-up signal, thereby avoiding waking up a plurality of unnecessary cells and reducing cell energy consumption.

### BRIEF DESCRIPTION OF DRAWINGS

FIG. 1 is a schematic architectural diagram of a communication system according to an embodiment of the present application;

FIG. 2 is a first schematic flowchart of a wake-up signal transmission method according to an embodiment of this application;

FIG. 3 is a schematic diagram of an example of a wake-up signal transmission method according to an embodiment of the present application;

FIG. 4 is a second schematic flowchart of a wake-up signal transmission method according to an embodiment of this application;

FIG. 5 is a first schematic diagram of a structure of a wake-up signal transmission apparatus according to an embodiment of the present application;

FIG. 6 is a second schematic diagram of a structure of a wake-up signal transmission apparatus according to an embodiment of the present application;

FIG. 7 is a schematic diagram of a structure of a terminal device according to an embodiment of the present application;

FIG. 8 is a schematic diagram of hardware of a terminal according to an embodiment of the present application; and

FIG. 9 is a schematic diagram of a hardware structure of a network side device according to an embodiment of the present application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th Generation (6G) communication system.

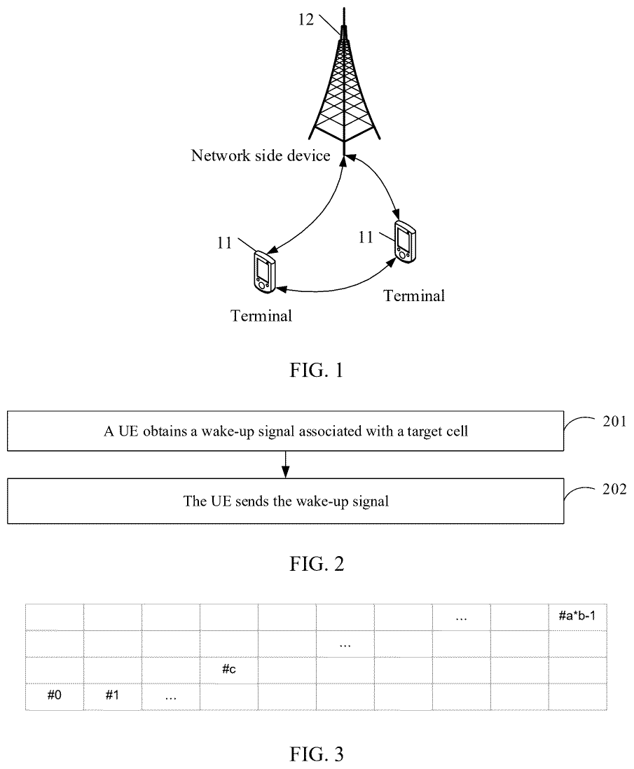

FIG. 1 is a block diagram of a wireless communication system to which the embodiments of this application may be applied. The wireless communication system includes a terminal 11 and a network side device 12. The terminal 11 may be a terminal side device such as User Equipment (UE), a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited.

The following describes in detail a wake-up signal transmission method and apparatus, a terminal, and a medium provided in the embodiments of this application through some embodiments and application scenarios thereof with reference to the accompanying drawings.

The following describes technical terms involved in the technical solution provided in this application.

### 1. Downlink (DL) Wake-Up Signal (WUS)

In a 5G system, to further improve power saving performance of a UE, a WUS based on Physical Downlink Control Channel (PDCCH) is introduced. A function of the WUS is to notify the UE whether the PDCCH needs to be monitored in onDuration of a specific Discontinuous Reception (DRX). In a case that there is no data, the UE may not need to monitor the PDCCH in onDuration. In other words, the UE may be in a sleep state in an entire DRX long cycle, thereby further saving power.

In some embodiments, the WUS is a type of Downlink Control Information (DCI), and may be generally referred to as DCI with Cyclic Redundancy Check (CRC) scrambled by Power Saving RNTI (PS-RNTI). The PS-RNTI is a Radio Network Temporary Identifier (RNTI) that is allocated by a network to the UE and that is used for a power saving characteristic, and the DCI scrambled by the RNTI carries a wake-up/sleep indication of the network for the UE. The UE determines, based on the indication, whether to enable an onDuration timer and whether to monitor the PDCCH in a next DRX cycle.

In the embodiments of this application, a wake-up signal sent by the UE may be an uplink (UL) wake-up signal, and the wake-up signal is mainly used to wake up a specific cell (namely, a target cell) to work. In other words, the wake-up signal in the embodiments of this application is used to indicate the target cell to switch from an energy-saving mode to a working mode, to realize data transmission with the UE.

### 2. Synchronization Signal/Physical Broadcast Channel Block (or Synchronization Signal and PBCH Block (SSB))

In the LTE, a terminal device realizes synchronization by using the base station by broadcasting a Primary Synchronization Signal (PSS) and a Secondary Synchronization Signal (SSS) that are sent. A concept of SSB appears in NR, and the SSB is formed by an original PSS, SSS, PBCH, and Demodulation Reference Signal (DMRS) received in four consecutive OFDM symbols, mainly used for downlink synchronization.

A cycle of the SSB may be 5, 10, 20, 40, 80, and 160 ms, and this cycle may be indicated in System Information Block (SIB) 1. The terminal has not received SIB1 during initial cell search, and the SSB may be searched based on a default cycle of 20 ms.

Because a synchronization grid and a frequency grid are not aligned in NR, a frequency deviation between No. 0 subcarrier of No. 0 RB of the SSB and No. 0 subcarrier of the lowest RB in a BWP overlapping with the SSB is referred to as kSSB.

The SSB in NR may be used for initial access of the terminal, and may also be used as a measurement reference signal to be configured for the terminal. The former is associated with SIB1, which is referred to as a cell-defining SSB, and the latter is referred to as a non cell-defining SSB. SIB1 includes information required for the terminal to stay in a cell, that is, the terminal can stay in the cell only when the cell-defining SSB is searched.

The terminal may obtain a value of kSSB by demodulating information of a Master Information Block (MIB) carried by the PBCH in the SSB. A Frequency Range (FR) 1 is used as an example, and a value range of kSSB is integers between 0 and 31. When kSSB is in a range [0, 23], the SSB is the cell-defining SSB; and when kSSB is in a range [24, 30], the SSB is the non cell-defining SSB. In this case, the network may indicate a location of the cell-defining SSB through bit in information fields of both kSSB and pdcch-ConfigSIB1. When kSSB=31, the terminal considers that there is no cell-defining SSB near a searched frequency point.

In the related art, when the base station provides cell residence for the terminal, at least uplink and downlink transmission channels need to be opened, that is, at least a public signal SSB/SIB1 is sent in a downlink direction, and an uplink direction may receive a random access request from the terminal.

However, in energy consumption of uplink and downlink transmission of a base station, downlink transmission accounts for a large proportion. To reduce energy consumption of the base station, the base station usually saves energy by shutting down downlink transmission and increasing a transmission cycle of a common signal. When the base station enters this kind of energy-saving mode, the base station needs to be assisted by a network or a terminal to return to a normal working mode from the energy-saving mode in a timely manner.

For example, when a network load is light (for example, there is little terminal traffic in an urban area in late night hours, and terminal density in a suburb is low), a network side device may enable a plurality of base stations to enter the energy-saving mode. If the terminal does not have a clear target network device when sending a wake-up signal to the network side device, a plurality of network side devices may be woken up. In fact, a terminal needs to stay in only one cell to maintain availability of the network. Therefore, that the terminal wakes up a plurality of network side devices may cause a certain amount of energy waste.

In a possible implementation, the network side device (such as a base stations) may be switched to some energy-saving modes for the purpose of energy saving. For example, the network may shut down part or all of downlink transmission of the base station, and enable the base station to continuously monitor a wake-up signal from the terminal or other device. When receiving the wake-up signal from the terminal, the base station may be switched to other base station states, such as a normal working mode or a lightly energy saving mode.

For example, the terminal may broadcast a wake-up signal to switch the base station from the energy-saving mode to the normal working mode, thereby realizing data transmission with the terminal. However, when the terminal broadcasts the wake-up signal, a plurality of base stations may be switched from the energy-saving mode to the normal working mode, which leads to a certain waste of energy consumption.

In conclusion, the terminal may wake up a specific target cell and avoid unnecessary energy consumption caused by waking up a plurality of base stations by which the wake-up signal is received when the terminal sends the wake-up signal.

In a wake-up signal transmission method and apparatus, a UE, a network side device, and a medium provided in the embodiments of this application, the UE may determine a wake-up signal associated with a target cell, and then send the wake-up signal to wake up the target cell. In this way, by determining the wake-up signal associated with the target cell in advance, the UE may wake up only the target cell associated with the wake-up signal after sending out the wake-up signal, thereby avoiding waking up a plurality of unnecessary cells and reducing cell energy consumption.

An embodiment of this application provides a wake-up signal transmission method. As shown in FIG. 2, the wake-up signal transmission method may include the following step 201 and step 202.

Step 201: A UE obtains a wake-up signal associated with a target cell.

Step 202: The UE sends the wake-up signal.

In this embodiment of this application, the wake-up signal is used to wake up the target cell to enter a working mode. In other words, the wake-up signal in the embodiments of this application is used to indicate the target cell to switch from an energy-saving mode to a working mode, to realize data transmission with the UE.

In this embodiment of this application, the UE may broadcast the wake-up signal associated with the target cell. In some embodiments, the UE may send the wake-up signal associated with the target cell to the target cell.

In this embodiment of this application, before the foregoing step 201, the wake-up signal transmission method provided in this embodiment of this application may further include the following step 301.

Step 301: The UE determines the target cell.

The following describes a process that the UE determines the target cell by using two possible embodiments.

In a possible embodiment, “the UE determines the target cell” in the foregoing step 301 may include the following step A1 and step A2.

Step A1: The UE performs signal measurement on N first cells in an energy-saving mode, to obtain a measurement result.

Step A2: The UE selects the target cell from the N first cells based on the measurement result.

In this embodiment of this application, the target cell is at least one of the N first cells, and N is a positive integer. For example, the N first cells are all in the energy-saving mode, in other words, the first cell may be referred to as an energy-saving cell.

In this embodiment of this application, when the UE determines that the energy-saving cell needs to be woken up, the UE may measure a reference signal from one or more energy-saving cells, and then, based on a measurement result, select at least one energy-saving cell from the one or more energy-saving cells as the target cell. For example, the reference signal of the energy-saving cell includes at least one of the following: an SSB, a Channel State Information (CSI) Reference Signal (CSI-RS), and a reference signal dedicated for measurement of the energy-saving cell.

In this embodiment of this application, the foregoing measurement result includes at least one of the following: Reference Signal Received Power (RSRP), Reference Signal Received Quality (RSRQ), and Received Signal Strength Indication (RSSI).

In a possible example, when the UE measures a reference signal of only one energy-saving cell, the UE selects the energy-saving cell as the target cell.

In another possible example, when the UE measures reference signals of a plurality of energy-saving cells, the UE selects at least one energy-saving cell with the best measurement result as the target cell.

In this embodiment of this application, the UE may measure a reference signal of one or more energy-saving cells in a measurement window.

In a possible example, window information of the measurement window is configured by a serving cell.

In a possible example, the window information of the measurement window includes at least one of the following:
a length of the measurement window;
a cycle of the measurement window;
a start location of the measurement window;
an end location of the measurement window; and
an offset value of the measurement window.

The offset value may be an offset value relative to a fixed time unit (for example, at least one of a frame, a subframe, a slot, and a symbol), and may also be an offset value relative to the start location of the measurement window. For example, the time unit corresponding to the offset value may be at least one of a frame, a subframe, a slot, and a symbol.

In this embodiment of this application, the UE may obtain the measurement result by measuring the reference signal of the energy-saving cell, and then determine the target cell based on the measurement result. In this way, the UE may directly measure the reference signal of the energy-saving cell in a case that not all downlink transmission channels of the energy-saving cell are closed, to determine a target cell, and further determine a wake-up signal associated with the target cell.

In another possible embodiment, “the UE determines the target cell” in the foregoing step 301 may include the following step B1 and step B2.

Step B1: The UE performs signal measurement on M second cells, to obtain a measurement result.

M is a positive integer.

In this embodiment of this application, each second cell is associated with at least one first cell in the energy-saving mode.

Step B2: The UE uses, based on the measurement result, a first cell associated with a target second cell as the target cell.

In this embodiment of this application, the target second cell is a second cell with a measurement result satisfying a first condition in the M second cells.

In this embodiment of this application, the first cell associated with the second cell refers to a first cell that is in a specific association relationship with the second cell. For example, the association relationship may be a location relationship between cells. For example, in a scenario of high-speed railway operation, cells that a high-speed railway passes through may be considered as being associated, or cells that are near in geographical location may also be associated.

In this embodiment of this application, that the measurement result satisfies the first condition may include any one of the following:
(1) the measurement result does not satisfy a cell reselection condition; and
(2) the measurement result does not satisfy the cell reselection condition, and the measurement result is higher than a reference signal measurement threshold of a second cell corresponding to the measurement result.

In this embodiment of this application, when the UE determines that the energy-saving cell needs to be woken up, the UE may measure a reference signal from one or more associated cells that are associated with an energy-saving cell, and then, based on a measurement result, select at least one energy-saving cell from one or more energy-saving cells that are associated with the associated cells as the target cell. For example, the reference signal of the associated cell includes at least one of the following: an SSB, a CSI-RS, and a reference signal dedicated for measurement of the associated cell.

In this embodiment of this application, after measuring the reference signal from the one or more associated cells that are associated with the energy-saving cell, the UE may use an energy-saving cell associated with an associated cell with a measurement result satisfying a predetermined condition as the target cell.

In a possible example, the predetermined condition includes at least one of the following.

Condition 1: All measurement results of reference signals of at least X associated cells that are associated are higher than measurement thresholds of corresponding associated cells.

Condition 2: All measurement results of reference signals of all associated cells that are associated are higher than measurement thresholds of corresponding associated cells, or all measurement results of reference signals of all associated cells that are associated are higher than a common measurement threshold.

For example, for condition 1, if all measurement results of at least N associated cells that are associated with energy-saving cell 1 are higher than measurement thresholds of corresponding associated cells, energy-saving cell 1 is used as the target cell. For example, if energy-saving cell 1 is associated with 4 associated cells (namely, associated cell a1, associated cell a2, associated cell a3, and associated cell a4), and it is assumed that X is 3. In this way, after the 4 associated cells are measured, if it is determined that a measurement result of associated cell a1 is higher than measurement threshold 1 corresponding to associated cell a1, a measurement result of associated cell a2 is higher than measurement threshold 2 corresponding to associated cell a2, and a measurement result of associated cell a3 is higher than measurement threshold 3 corresponding to associated cell a3, energy-saving cell 1 may be used as the target cell.

For example, for condition 2, if all measurement results of all associated cells that are associated with energy-saving cell 2 are higher than corresponding measurement thresholds (that is, measurement thresholds respectively corresponding to all measurement cells, or the common measurement threshold), energy-saving cell 2 is used as the target cell. For example, if energy-saving cell 2 is associated with 4 associated cells (namely, associated cell b1, associated cell b2, associated cell b3, and associated cell b4), after the 4 associated cells are measured, it is determined that a measurement result of associated cell b1 is higher than measurement threshold 1′ corresponding to associated cell b1, a measurement result of associated cell b2 is higher than measurement threshold 2′ corresponding to associated cell b2, a measurement result of associated cell b3 is higher than measurement threshold 3′ corresponding to associated cell b3, and a measurement result of associated cell b4 is higher than measurement threshold 4′ corresponding to associated cell b4, energy-saving cell 2 may be used as the target cell. In some embodiments, if all the measurement results of the 4 associated cells are higher than common measurement threshold a, energy-saving cell 2 may be used as the target cell.

It should be noted that the energy-saving cell is usually located near the UE.

An SSB for measuring an associated cell of the energy-saving cell is used as an example.

(1) If an SSB measurement result of the associated cell satisfies cell selection/reselection, a cell selection/reselection process is directly followed, and the terminal does not need to send a wake-up signal.

(2) If the SSB measurement result of the associated cell does not satisfy cell selection/reselection, but is higher than a specific threshold, it is considered that the UE is at the edge of the associated cell, and in this case, the UE may be near an energy-saving cell corresponding to the associated cell. In this way, a wake-up signal may be sent to the energy-saving cell corresponding to the associated cell, to wake up the energy-saving cell for data transmission.

It should be noted that if not all downlink transmission channels of the energy-saving cell are closed, the reference signal of the energy-saving cell may be directly measured to directly determine the target cell based on a measurement result; and if all of the downlink transmission channels of the energy-saving cell are closed, the reference signal of the associated cell that is associated with the energy-saving cell needs to be measured, to indirectly determine the target cell based on a measurement result.

In this embodiment of this application, the UE may perform signal measurement on a second cell associated with the energy-saving cell, determine the target second cell based on a measurement result, and then determine an energy-saving cell associated with the target second cell as the target cell. In this way, in a case that all of the downlink transmission channels of the energy-saving cell are closed, the UE may measure the associated cell that is associated with the energy-saving cell, to indirectly determine the target cell, to further determine a wake-up signal associated with the target cell.

In this embodiment of this application, “A UE obtains a wake-up signal associated with a target cell” in the foregoing step 201 may include step 201a.

Step 201a: The UE determines the wake-up signal based on a wake-up signal configuration associated with the target cell.

In a possible example, when the UE measures a reference signal of only one energy-saving cell, the UE selects a wake-up signal configuration associated with the energy-saving cell, and determines a wake-up signal to be sent.

In another possible example, when the UE measures reference signals of a plurality of energy-saving cells, the UE selects a wake-up signal configuration associated with at least one energy-saving cell with the best measurement result, and determines a wake-up signal to be sent.

In this embodiment of this application, the wake-up signal transmission method provided in this embodiment of this application may further include the following step 302.

Step 302: The UE obtains a first configuration configured for the UE by a network side device.

In this embodiment of this application, the first configuration includes a cell configuration of at least one of the first cells.

For example, a serving cell of the UE may configure an energy-saving cell configuration list for the UE (that is, the first configuration), such as EnergySavingCellConfigList. Each element in the energy-saving cell configuration list corresponds to a configuration of an energy-saving cell, such as EnergySavingCellConfig.

In this embodiment of this application, a cell configuration of each of the first cells includes at least one of the following:
a cell identifier of the first cell (such as PhysCellId); and
cell information of a second cell associated with the first cell.

In a possible example, the cell information of the second cell associated with the first cell may be a cell information list of the second cell associated with the first cell, such as AssociatedCellList. For example, the AssociatedCellList may include cell information of an associated cell (that is, the second cell) of at least one first cell.

In a possible example, the cell information of the second cell includes at least one of the following:
a cell identifier of the second cell (such as PhysCellId); and
a reference signal measurement threshold (such as rsrpAssociatedCellThreshold) of the second cell.

In this embodiment of this application, after obtaining the first configuration configured for the UE by the network side device, the UE may determine the target cell based on the first configuration.

In this embodiment of this application, the wake-up signal associated with the target cell may include a wake-up signal characteristic, where the wake-up signal characteristic may indicate the target cell.

In this embodiment of this application, “A UE obtains a wake-up signal associated with a target cell” in the foregoing step 201 may include step 201b.

Step 201b: The UE determines, based on a second configuration, the wake-up signal associated with the target cell.

In this embodiment of this application, the second configuration is configured for the UE by the network side device.

In this embodiment of this application, the second configuration includes at least one of the following:
a cell identifier (such as PhysCellId) of at least one first cell in an energy-saving mode; and
a wake-up signal characteristic configuration corresponding to each of the first cells.

In this embodiment of this application, the target cell is one or more cells in the at least one first cell.

In this embodiment of this application, the wake-up signal characteristic included in the wake-up signal associated with the target cell is configured based on a wake-up signal characteristic configuration corresponding to the target cell.

In this embodiment of this application, the UE may generate, based on the second configuration, a wake-up signal sequence associated with the target cell.

In this embodiment of this application, each first cell corresponds to a wake-up signal characteristic configuration.

In this embodiment of this application, the wake-up signal characteristic configuration includes at least one of the following:
a start location K of a wake-up signal sequence;
an end location Y of a wake-up signal sequence;
a quantity P of wake-up signal sequences;
a length of a wake-up signal sequence;
an index or an index range of a wake-up signal sequence;
an index or an index range of a wake-up signal scrambling sequence;
a root sequence of a wake-up signal sequence, or a root sequence list of a wake-up signal sequence; and
a transmit power of a wake-up signal, or a transmit power list of a wake-up signal.

In this embodiment of this application, 0<=K<=Y.

In this embodiment of this application, P is a positive integer.

For example, the wake-up signal sequence may include a preamble sequence number. For example, for the UE, when the UE expects to send a wake-up signal to the target cell, the UE selects a preamble between [K, Y] based on preamble sequence information (for example, a start location of a preamble sequence is K, and an end location of the preamble sequence is K) configured in a wake-up signal characteristic configuration corresponding to the target cell, and then generates a wake-up signal sequence based on the preamble (that is, the preamble is included in the wake-up signal sequence for sending).

For example, for the UE, when the UE expects to send a wake-up signal to the target cell, the UE selects a preamble with a preamble sequence between [0, P] based on preamble sequence information (for example, a quantity of preamble sequences is P) configured in a wake-up signal characteristic configuration corresponding to the target cell, and then generates a wake-up signal sequence based on the preamble (that is, the preamble is included in the wake-up signal sequence for sending).

For example, for the UE, when the UE expects to send a wake-up signal to the target cell, the UE selects, based on a root sequence list configured in a wake-up signal characteristic configuration corresponding to the target cell, a wake-up signal sequence corresponding to or generated by at least one root sequence of the root sequence list, and then sends the wake-up signal sequence.

In this embodiment of this application, “The UE sends the wake-up signal” in the foregoing step 202 may include step 202a.

Step 202a: The UE sends, on a target resource, the wake-up signal associated with the target cell.

In this embodiment of this application, the target resource indicates the target cell. In this embodiment of this application, the target resource includes at least one of the following:
a time domain resource; and
a frequency domain resource.

In this embodiment of this application, a resource location of the target resource is associated with a physical identifier corresponding to the target cell.

For example, the physical identifier corresponding to the target cell includes a PCI corresponding to the target cell.

It should be noted that the UE may determine a PCI of a cell by using a synchronization signal (for example, SSB in NR and PSS/SSS in LTE) of an energy-saving cell. In some embodiments, an LTE system provides 504 PCIs, and an NR system provides 1008 PCIs. In this way, when determining to send a wake-up signal to an energy-saving cell, the UE may determine, by using a PCI of the energy-saving cell after monitoring a synchronization signal of the energy-saving cell, a resource location of a time-frequency resource on which the wake-up signal is sent. In a first possible example:

The UE may determine, by using a PCI of an energy-saving cell, a resource location of a time domain resource on which a wake-up signal is sent.

For example, if PCI % C=a (C is a positive integer, and a is a natural number), the UE may send a wake-up signal in any one of the following manners:
(1) send the wake-up signal in a subframe offset from a first subframe (for example, (subframe) #0) by a subframes in each system frame;
(2) send the wake-up signal in a slot offset from a first slot (for example, (slot) #0) by a slots in each system frame; and
(3) send the wake-up signal in a symbol offset from a first symbol (for example, (symbol) #0) of the first slot (for example, (slot) #0) by a symbols in each system frame.

For example, the system frame may be a 1^{st} system frame within a wake-up signal cycle. A wake-up signal cycle includes one or more system frames.

In a second possible example:

When the UE is configured with M frequency domain resources that may be used to send a wake-up signal, if PCI % D=b (D is a positive integer, and b is a natural number), the UE may send the wake-up signal on a frequency domain resource with a sequence number of b.

It should be noted that the foregoing two examples may be realized independently. For example, when a frequency domain resource of the wake-up signal is fixed, or there is only one frequency domain resource of the wake-up signal, a time domain location at which the wake-up signal is sent is determined through the first possible example; and for another example, when the wake-up signal is sent at a fixed time domain location of a system frame or a wake-up signal cycle, or there is only one time domain location available for sending the wake-up signal, a frequency domain location at which the wake-up signal is sent may be determined through the second possible example.

In addition, as shown in FIG. 3, the foregoing two examples may be combined for implementation. For example, if the time domain resource and the frequency domain resource on which the UE sends the wake-up signal are in the form of gridded numbers, the UE may send the wake-up signal on a time-frequency domain resource with a sequence number of k by calculating PCI % (C*D)=k (C and D are positive integers, and k is a natural number). Otherwise, the time domain location and the frequency domain location at which the UE sends the wake-up signal may be determined separately in the foregoing manners: PCI % C=a, and PCI % D=b.

In this embodiment of this application, the UE transmits a wake-up signal on a specific time-frequency domain resource, so that the network side device may determine, based on the time-frequency domain resource, a target cell that the UE expects to wake up, and then directly wake up the target cell, thereby avoiding waking up a plurality of unnecessary cells and reducing energy consumption of the cells.

In this embodiment of this application, the wake-up signal carries a cell identifier of the target cell.

In this embodiment of this application, the wake-up signal associated with the target cell may carry the cell identifier of the target cell, so that the UE may directly wake up the target cell after directly sending the wake-up signal to the target cell, thereby avoiding waking up a plurality of unnecessary cells and reducing energy consumption of the cells.

In the wake-up signal transmission method provided in this embodiment of this application, the UE may determine a wake-up signal associated with a target cell, and then send the wake-up signal to wake up the target cell. In this way, by determining the wake-up signal associated with the target cell in advance, the UE may wake up only the target cell associated with the wake-up signal after sending out the wake-up signal, thereby avoiding waking up a plurality of unnecessary cells and reducing cell energy consumption.

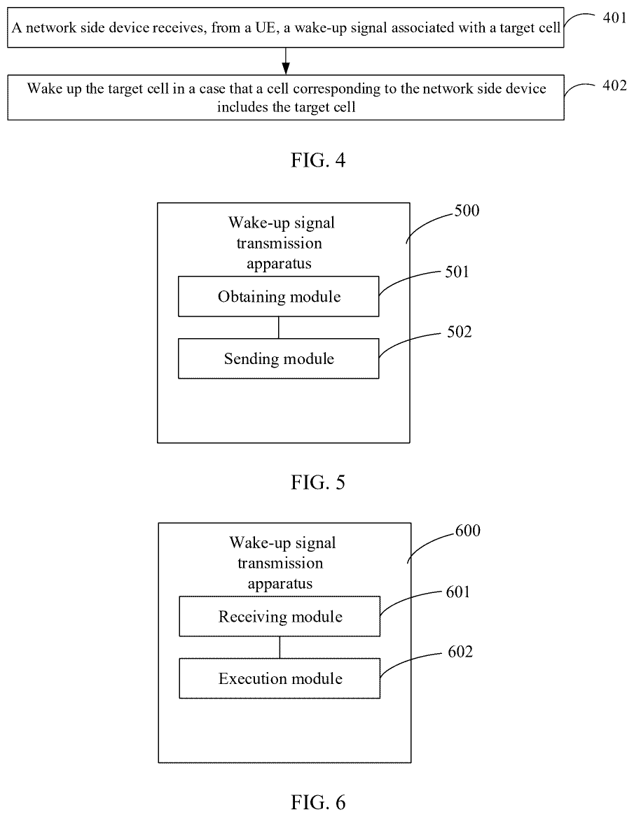

An embodiment of this application provides a wake-up signal transmission method. As shown in FIG. 4, the wake-up signal transmission method may include the following step 401 and step 402.

Step 401: A network side device receives, from a UE, a wake-up signal associated with a target cell.

Step 402: Wake up the target cell in a case that a cell corresponding to the network side device includes the target cell.

In this embodiment of this application, after receiving the wake-up signal that is associated with the target cell and that is sent by the UE, the network side device may determine whether the cell corresponding to the network side device includes the target cell, if the target cell is included, the target cell is woken up based on the wake-up signal, otherwise, if the target cell is not included, no operation is performed, in other words, the network side device has no cell to wake up.

In this embodiment of this application, the cell corresponding to the network side device may be considered as a cell covered by the network side device, or a cell that the network side device may control.

It should be noted that, for related descriptions of the wake-up signal and the target cell, refer to the foregoing detailed descriptions of the wake-up signal and the target cell, and details are not repeated herein again.

In this embodiment of this application, the wake-up signal transmission method provided in this embodiment of this application may further include step 403.

Step 403: The network side device configures a first configuration for the UE.

The first configuration includes a cell configuration of at least one of first cells.

It should be noted that, for related descriptions of the first configuration, refer to the foregoing detailed descriptions of the first configuration. To avoid repetition, details are not repeated herein again.

In this embodiment of this application, the wake-up signal includes a wake-up signal characteristic, where the wake-up signal characteristic indicates the target cell.

In this embodiment of this application, the wake-up signal transmission method provided in this embodiment of this application may further include step 404.

Step 404: The network side device configures a second configuration for the UE.

It should be noted that, for related descriptions of the second configuration, refer to the foregoing detailed descriptions of the second configuration. To avoid repetition, details are not repeated herein again.

In this embodiment of this application, a process of “A network side device receives, from a UE, a wake-up signal associated with a target cell” in the foregoing step 402 may include the following step 402a.

Step 402a: The network side device receives, on a target resource, the wake-up signal that is associated with the target cell and that is sent by the UE.

The target resource indicates the target cell.

In this embodiment of this application, the target resource includes at least one of the following:
a time domain resource; and
a frequency domain resource.

In this embodiment of this application, a resource location of the target resource is associated with a physical identifier corresponding to the target cell.

In this embodiment of this application, the wake-up signal carries a cell identifier of the target cell.

In the wake-up signal transmission method provided in this embodiment of this application, after receiving the wake-up signal that is associated with the target cell and that is sent by the UE, the network side device may wake up the target cell based on the wake-up signal if a cell corresponding to the network side device includes the target cell. In this way, because the wake-up signal sent by the UE is the wake-up signal associated with the target cell, the network side device may wake up only a target cell associated with the wake-up signal, thereby avoiding waking up a plurality of unnecessary cells and reducing cell energy consumption.

It should be noted that content in the method embodiment corresponding to FIG. 2 may be realized by combining with content in the method embodiment corresponding to FIG. 4, or may be realized separately, which is not limited in the embodiments of this application.

The following describes the wake-up signal transmission method provided in the embodiments of this application by using two embodiments as examples.

### Embodiment 1

If an energy-saving cell sends an SSB as a reference signal, when a UE detects the SSB of the energy-saving cell, a cell identifier PhysCellId of the energy-saving cell may be resolved through the SSB. For example, if the UE measures SSBs of a plurality of energy-saving cells and selects an energy-saving cell with the best SSB measurement result, it can decode the cell identifier PhysCellId of the energy-saving cell. In this case, the UE may perform at least one of the following steps (step S1 and step S2).

Step S1: If the cell identifier PhysCellId of the energy-saving cell is the same as an energy-saving cell identifier in an energy-saving cell configuration in the second configuration, the UE determines, based on a WUS characteristic configuration in the energy-saving cell configuration in the second configuration, a WUS sequence to be sent. The UE then sends a WUS to the energy-saving cell.

Step S2: The UE calculates, by using the cell identifier PhysCellId of the energy-saving cell, a time-frequency location at which the UE sends the WUS, and the UE sends the WUS at the time-frequency location. The WUS may be a WUS determined through the WUS characteristic configuration, or may be other WUSs, which is not limited herein.

In some embodiments, the WUS includes or indicates the cell identifier of the energy-saving cell.

### Embodiment 2

If the UE determines, by measuring a reference signal of an associated cell of an energy-saving cell, a target energy-saving cell to which a WUS is sent, in this case, the UE may perform at least one of the following steps (step S3 and step S4).

Step S3: If the cell identifier PhysCellId of the energy-saving cell is the same as an energy-saving cell identifier in an energy-saving cell configuration in the second configuration, the UE determines, based on a WUS characteristic configuration in the energy-saving cell configuration in the second configuration, a WUS (sequence) to be sent. The UE then sends the WUS to the energy-saving cell.

Step S4: The UE calculates, by using the cell identifier PhysCellId of the energy-saving cell, a time-frequency location at which the UE sends the WUS, and the UE sends the WUS at the time-frequency location. The WUS may be a WUS determined through the WUS characteristic configuration, or may be other WUSs, which is not limited herein.

In some embodiments, the WUS includes or indicates the cell identifier of the energy-saving cell.

The wake-up signal transmission method provided in this embodiment of this application may be executed by a wake-up signal transmission apparatus. In this embodiment of this application, that the wake-up signal transmission apparatus performs the wake-up signal transmission method is used as an example to describe the wake-up signal transmission apparatus provided in this embodiment of this application.

An embodiment of this application provides a wake-up signal transmission apparatus. As shown in FIG. 5, the wake-up signal transmission apparatus 500 includes an obtaining module 501 and a sending module 502, where the obtaining module 501 is configured to obtain a wake-up signal associated with a target cell; and the sending module 502 is configured to send the wake-up signal obtained by the obtaining module 501.

In this embodiment of this application, the wake-up signal transmission apparatus 500 further includes a determining module 503, where the determining module 503 is configured to determine the target cell.

In this embodiment of this application, the wake-up signal transmission apparatus 500 further includes a measurement module 504, where the measurement module 504 is configured to perform signal measurement on N first cells in an energy-saving mode, to obtain a measurement result; and the determining module 503 is configured to select the target cell from the N first cells based on the measurement result, where the target cell is at least one of the N first cells; and Nis a positive integer.

In this embodiment of this application, the measurement module 504 is configured to perform signal measurement on M second cells, to obtain a measurement result, where each second cell is associated with at least one first cell in the energy-saving mode, and M is a positive integer; and the determining module 503 is configured to use, based on the measurement result, a first cell associated with a target second cell as the target cell, where the target second cell is a second cell with a measurement result satisfying a first condition in the M second cells.

In this embodiment of this application, the determining module 503 is configured to determine the wake-up signal based on a wake-up signal configuration associated with the target cell.

In this embodiment of this application, the obtaining module 501 is further configured to obtain a first configuration configured for the UE by a network side device, where the first configuration includes a cell configuration of at least one of the first cells; and a cell configuration of each of the first cells includes at least one of the following: a cell identifier of the first cell; and cell information of a second cell associated with the first cell.

In this embodiment of this application, the cell information of the second cell includes at least one of the following: a cell identifier of the second cell; and a reference signal measurement threshold of the second cell.

In this embodiment of this application, that the measurement result satisfies a first condition includes any one of the following: the measurement result does not satisfy a cell reselection condition; and the measurement result does not satisfy the cell reselection condition, and the measurement result is higher than a reference signal measurement threshold of a second cell corresponding to the measurement result.

In this embodiment of this application, the wake-up signal includes a wake-up signal characteristic, where the wake-up signal characteristic indicates the target cell.

In this embodiment of this application, the determining module 503 is configured to determine, based on a second configuration, the wake-up signal associated with the target cell, where the second configuration is configured for the UE by a network side device; and the second configuration includes at least one of the following: a cell identifier of at least one first cell in an energy-saving mode; a wake-up signal characteristic configuration corresponding to each of the first cells; the target cell is one or more cells in the at least one first cell; and the wake-up signal characteristic is configured based on a wake-up signal characteristic configuration corresponding to the target cell.

In this embodiment of this application, the wake-up signal characteristic configuration includes at least one of the following: a start location of a wake-up signal sequence; an end location of a wake-up signal sequence; a quantity of wake-up signal sequences; a length of a wake-up signal sequence; an index or an index range of a wake-up signal sequence; an index or an index range of a wake-up signal scrambling sequence; a root sequence of a wake-up signal sequence, or a root sequence list of a wake-up signal sequence; and a transmit power of a wake-up signal, or a transmit power list of a wake-up signal.

In this embodiment of this application, the sending module 502 is configured to send the wake-up signal on a target resource, where the target resource indicates the target cell; and the target resource includes at least one of the following: a time domain resource; and a frequency domain resource.

In this embodiment of this application, a resource location of the target resource is associated with a physical identifier corresponding to the target cell.

In this embodiment of this application, the wake-up signal carries a cell identifier of the target cell.

In the wake-up signal transmission apparatus provided in this embodiment of this application, the apparatus may determine a wake-up signal associated with a target cell, and then send the wake-up signal to wake up the target cell. In this way, the wake-up signal associated with the target cell is determined in advance, and therefore, only the target cell associated with the wake-up signal is woken up after the wake-up signal is sent out, thereby avoiding waking up a plurality of unnecessary cells and reducing cell energy consumption.

An embodiment of this application provides a wake-up signal transmission apparatus. As shown in FIG. 6, the wake-up signal transmission apparatus 600 includes a receiving module 601 and an execution module 602, where the receiving module 601 is configured to receive, from a UE, a wake-up signal associated with a target cell; and the execution module 602 is configured to: in a case that a cell corresponding to the network side device includes the target cell, wake up the target cell received by the receiving module 601.

In this embodiment of this application, the wake-up signal transmission apparatus 600 further includes a configuring module 603, where the configuring module 603 is configured to configure a first configuration for the UE, where the first configuration includes a cell configuration of at least one of the first cells; and a cell configuration of each of the first cells includes at least one of the following: a cell identifier of the first cell; and cell information of a second cell associated with the first cell.

In this embodiment of this application, the cell information of the second cell includes at least one of the following: a cell identifier of the second cell; and a reference signal measurement threshold of the second cell.

In this embodiment of this application, the wake-up signal includes a wake-up signal characteristic, where the wake-up signal characteristic indicates the target cell.

In this embodiment of this application, the configuring module 603 is further configured to configure a second configuration for the UE, where the second configuration includes at least one of the following: a cell identifier of at least one first cell in an energy-saving mode; a wake-up signal characteristic configuration corresponding to each of the first cells; the target cell is one or more cells in the at least one first cell; and the wake-up signal characteristic is configured based on a wake-up signal characteristic configuration corresponding to the target cell.

In this embodiment of this application, the wake-up signal characteristic configuration includes at least one of the following: a start location of a wake-up signal sequence; an end location of a wake-up signal sequence; a quantity of wake-up signal sequences; a length of a wake-up signal sequence; an index or an index range of a wake-up signal sequence; an index or an index range of a wake-up signal scrambling sequence; a root sequence of a wake-up signal sequence, or a root sequence list of a wake-up signal sequence; and a transmit power of a wake-up signal, or a transmit power list of a wake-up signal.

In this embodiment of this application, the receiving module 601 is configured to receive, on a target resource, the wake-up signal that is associated with the target cell and that is sent by the UE, where the target resource indicates the target cell; and the target resource includes at least one of the following: a time domain resource; and a frequency domain resource.

In this embodiment of this application, a resource location of the target resource is associated with a physical identifier corresponding to the target cell.

In this embodiment of this application, the wake-up signal carries a cell identifier of the target cell.

In the wake-up signal transmission apparatus provided in this embodiment of this application, after receiving the wake-up signal that is associated with the target cell and that is sent by the UE, the apparatus may wake up the target cell based on the wake-up signal if a cell corresponding to the network side device used in the apparatus includes the target cell. In this way, because the wake-up signal sent by the UE is the wake-up signal associated with the target cell, the network side device may wake up only a target cell associated with the wake-up signal, thereby avoiding waking up a plurality of unnecessary cells and reducing cell energy consumption.

The wake-up signal transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), and the like. This is not specifically limited in this embodiment of this application.

The wake-up signal transmission apparatus provided in this embodiment of this application can implement the processes implemented in the foregoing method embodiments, and achieve a same technical effect. To avoid repetition, details are not described herein again.

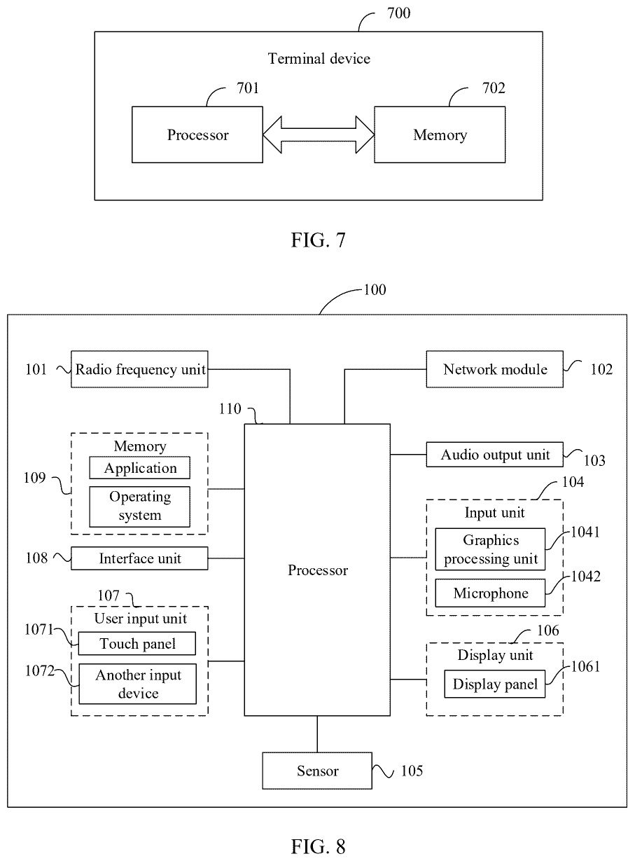

For example, as shown in FIG. 7, an embodiment of this application further provides a terminal device 700, including a processor 701 and a memory 702, and the memory 702 stores a program or an instruction that can be run on the processor 701. When the program or the instruction is executed by the processor 701, the steps of the foregoing wake-up signal transmission method embodiments are implemented, and a same technical effect can be achieved. To avoid repetition, details are not described herein again. In a case that the communication device 700 is a network side device, when the program or the instruction is executed by the processor 701, the steps of the foregoing wake-up signal transmission method embodiments are implemented, and a same technical effect can be achieved. To avoid repetition, details are not described herein again.

An embodiment of this application further provides a terminal, including a processor and a communication interface. The processor is configured to determine a wake-up signal associated with a target cell, and the communication interface is configured to send the wake-up signal. The terminal embodiment is corresponding to the method embodiment on the terminal side, each implementation process and implementation of the method embodiment can be applied to the terminal embodiment, and a same technical effect can be achieved. For example, FIG. 8 is a schematic diagram of a hardware structure of a terminal according to an embodiment of this application.

The terminal 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include a power supply (such as a battery) that supplies power to each component. The power supply may be logically connected to the processor 110 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 104 may include a Graphics Processing Unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in this embodiment of this application includes but is not limited to these memories and any memory of another proper type.

The processor 110 may include one or more processing units. In some embodiments, an application processor and a modem processor are integrated into the processor 110. The application processor mainly processes an operating system, a user interface, an application, and the like. The modem processor mainly processes a wireless communication signal, for example, a baseband processor. It may be understood that, in some embodiments, the modem processor may not be integrated into the processor 110.

The processor 110 is configured to obtain a wake-up signal associated with a target cell, and the radio frequency unit 101 is configured to send the wake-up signal obtained by the processor 110.

In this embodiment of this application, the processor 110 is further configured to determine the target cell.

In this embodiment of this application, the processor 110 is further configured to perform signal measurement on N first cells in an energy-saving mode, to obtain a measurement result; and the processor 110 is configured to select the target cell from the N first cells based on the measurement result, where the target cell is at least one of the N first cells; and N is a positive integer.

In this embodiment of this application, the processor 110 is further configured to perform signal measurement on M second cells, to obtain a measurement result, where each second cell is associated with at least one first cell in the energy-saving mode, and M is a positive integer; and the processor 110 is configured to use, based on the measurement result, a first cell associated with a target second cell as the target cell, where the target second cell is a second cell with a measurement result satisfying a first condition in the M second cells.

In this embodiment of this application, the processor 110 is configured to determine the wake-up signal based on a wake-up signal configuration associated with the target cell.

In this embodiment of this application, the input unit 104 is configured to obtain a first configuration configured for the terminal by a network side device, where the first configuration includes a cell configuration of at least one of the first cells; and a cell configuration of each of the first cells includes at least one of the following: a cell identifier of the first cell; and cell information of a second cell associated with the first cell.

In this embodiment of this application, the cell information of the second cell includes at least one of the following: a cell identifier of the second cell; and a reference signal measurement threshold of the second cell.

In this embodiment of this application, that the measurement result satisfies a first condition includes any one of the following: the measurement result does not satisfy a cell reselection condition; and the measurement result does not satisfy the cell reselection condition, and the measurement result is higher than a reference signal measurement threshold of a second cell corresponding to the measurement result.

In this embodiment of this application, the wake-up signal includes a wake-up signal characteristic, where the wake-up signal characteristic indicates the target cell.

In this embodiment of this application, the processor 110 is configured to determine, based on a second configuration, the wake-up signal associated with the target cell, where the second configuration is configured for the terminal by a network side device; and the second configuration includes at least one of the following: a cell identifier of at least one first cell in an energy-saving mode; a wake-up signal characteristic configuration corresponding to each of the first cells; the target cell is one or more cells in the at least one first cell; and the wake-up signal characteristic is configured based on a wake-up signal characteristic configuration corresponding to the target cell.

In this embodiment of this application, the wake-up signal characteristic configuration includes at least one of the following: a start location of a wake-up signal sequence; an end location of a wake-up signal sequence; a quantity of wake-up signal sequences; a length of a wake-up signal sequence; an index or an index range of a wake-up signal sequence; an index or an index range of a wake-up signal scrambling sequence; a root sequence of a wake-up signal sequence, or a root sequence list of a wake-up signal sequence; and a transmit power of a wake-up signal, or a transmit power list of a wake-up signal.

In this embodiment of this application, the radio frequency unit 101 is configured to send the wake-up signal on a target resource, where the target resource indicates the target cell; and the target resource includes at least one of the following: a time domain resource; and a frequency domain resource.

In this embodiment of this application, a resource location of the target resource is associated with a physical identifier corresponding to the target cell.

In this embodiment of this application, the wake-up signal carries a cell identifier of the target cell.

In the terminal device provided in the embodiments of this application, the terminal may obtain a wake-up signal associated with a target cell, and then send the wake-up signal to wake up the target cell. In this way, by determining the wake-up signal associated with the target cell in advance, the terminal may wake up only the target cell associated with the wake-up signal after sending out the wake-up signal, thereby avoiding waking up a plurality of unnecessary cells and reducing cell energy consumption.

An embodiment of this application further provides a network side device, including a processor and a communication interface. The communication interface is configured to receive, from a terminal, a wake-up signal associated with a target cell; and the processor is configured to: in a case that a cell corresponding to the network side device includes the target cell, wake up the target cell. This network side device embodiment is corresponding to the foregoing method embodiment of the network side device. Each implementation process and implementation of the foregoing method embodiment may be applicable to this network side device embodiment, and a same technical effect can be achieved.

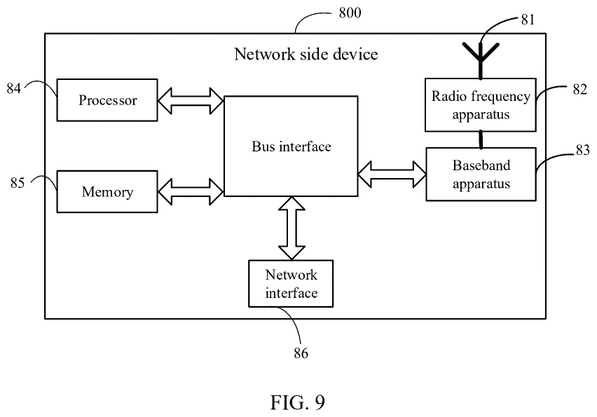

For example, an embodiment of this application further provides a network side device. As shown in FIG. 9, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 9, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a Common Public Radio Interface (CPRI).

For example, the network side device 800 in this embodiment of the present application further includes an instruction or a program that is stored in the memory 85 and that can be run on the processor 84. The processor 84 invokes the instruction or the program in the memory 85 to perform the method performed by the modules shown in FIG. 6, and a same technical effect is achieved. To avoid repetition, details are not described herein again.

The antenna 81 is configured to receive, from a UE, a wake-up signal associated with a target cell; and the processor 84 is configured to: in a case that a cell corresponding to the network side device includes the target cell, wake up the target cell received by the antenna 81.

In this embodiment of this application, the baseband apparatus 83 is configured to configure a first configuration for the UE, where the first configuration includes a cell configuration of at least one of the first cells; and a cell configuration of each of the first cells includes at least one of the following: a cell identifier of the first cell; and cell information of a second cell associated with the first cell.

In this embodiment of this application, the cell information of the second cell includes at least one of the following: a cell identifier of the second cell; and a reference signal measurement threshold of the second cell.

In this embodiment of this application, the wake-up signal includes a wake-up signal characteristic, where the wake-up signal characteristic indicates the target cell.

In this embodiment of this application, the baseband apparatus 83 is further configured to configure a second configuration for the UE, where the second configuration includes at least one of the following: a cell identifier of at least one first cell in an energy-saving mode; a wake-up signal characteristic configuration corresponding to each of the first cells; the target cell is one or more cells in the at least one first cell; and the wake-up signal characteristic is configured based on a wake-up signal characteristic configuration corresponding to the target cell.

In this embodiment of this application, the wake-up signal characteristic configuration includes at least one of the following: a start location of a wake-up signal sequence; an end location of a wake-up signal sequence; a quantity of wake-up signal sequences; a length of a wake-up signal sequence; an index or an index range of a wake-up signal sequence; an index or an index range of a wake-up signal scrambling sequence; a root sequence of a wake-up signal sequence, or a root sequence list of a wake-up signal sequence; and a transmit power of a wake-up signal, or a transmit power list of a wake-up signal.

In this embodiment of this application, the antenna 81 is configured to receive, on a target resource, the wake-up signal that is associated with the target cell and that is sent by the UE, where the target resource indicates the target cell; and the target resource includes at least one of the following: a time domain resource; and a frequency domain resource.

In this embodiment of this application, a resource location of the target resource is associated with a physical identifier corresponding to the target cell.

In this embodiment of this application, the wake-up signal carries a cell identifier of the target cell.

In the network side device provided in this embodiment of this application, after receiving the wake-up signal that is associated with the target cell and that is sent by the UE, the network side device may wake up the target cell based on the wake-up signal if a cell corresponding to the network side device includes the target cell. In this way, because the wake-up signal sent by the UE is the wake-up signal associated with the target cell, the network side device may wake up only a target cell associated with the wake-up signal, thereby avoiding waking up a plurality of unnecessary cells and reducing cell energy consumption.

An embodiment of this application further provides a readable storage medium. The readable storage medium stores a program or an instruction, and when the program or the instruction is executed by a processor, the processes of the foregoing wake-up signal transmission method embodiments are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing wake-up signal transmission method embodiments, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing wake-up signal transmission method embodiments, and a same technical effect can be achieved. To avoid repetition, details are not described herein again.

An embodiment of this application further provides a wake-up signal transmission system, including a terminal and a network side device, where the terminal may be configured to perform the steps of the wake-up signal transmission method from step 201 to step 302, and the network side device may be configured to perform the steps of the wake-up signal transmission method from step 401 to step 404.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A wake-up signal transmission method, comprising:
obtaining, by a User Equipment (UE), a wake-up signal associated with a target cell; and
sending, by the UE, the wake-up signal.

2. The wake-up signal transmission method according to claim 1, wherein before the obtaining, by the UE, the wake-up signal associated with the target cell, the method further comprises:
determining, by the UE, the target cell.

3. The wake-up signal transmission method according to claim 2, wherein the determining, by the UE, the target cell comprises:
performing, by the UE, signal measurement on N first cells in an energy-saving mode, to obtain a measurement result; and
selecting, by the UE, the target cell from the N first cells based on the measurement result,
wherein the target cell is at least one of the N first cells, and N is a positive integer.

4. The wake-up signal transmission method according to claim 2, wherein the determining, by the UE, the target cell comprises:
performing, by the UE, signal measurement on M second cells, to obtain a measurement result, wherein each second cell is associated with at least one first cell in an energy-saving mode, and M is a positive integer; and
using, by the UE based on the measurement result, a first cell associated with a target second cell as the target cell, wherein the target second cell is a second cell with a measurement result satisfying a first condition in the M second cells.

5. The wake-up signal transmission method according to claim 1, wherein the obtaining, by the UE, the wake-up signal associated with the target cell comprises:
determining, by the UE, the wake-up signal based on a wake-up signal configuration associated with the target cell.

6. The wake-up signal transmission method according to 1, further comprising:
obtaining, by the UE, a first configuration configured for the UE by a network side device,
wherein the first configuration comprises a cell configuration of at least one of the first cells;
and a cell configuration of each of the first cells comprises at least one of the following:
a cell identifier of the first cell; or
cell information of a second cell associated with the first cell.

7. The wake-up signal transmission method according to claim 6, wherein the cell information of the second cell comprises at least one of the following:
a cell identifier of the second cell; or
a reference signal measurement threshold of the second cell.

8. The wake-up signal transmission method according to claim 4, wherein the measurement result satisfies the first condition comprises any one of the following:
the measurement result does not satisfy a cell reselection condition; or
the measurement result does not satisfy the cell reselection condition, and the measurement result is higher than a reference signal measurement threshold of a second cell corresponding to the measurement result.

9. The wake-up signal transmission method according to claim 1, wherein the wake-up signal comprises a wake-up signal characteristic, wherein the wake-up signal characteristic indicates the target cell.

10. The wake-up signal transmission method according to claim 9, wherein the obtaining, by the UE, the wake-up signal associated with the target cell comprises:
determining, by the UE based on a second configuration, the wake-up signal associated with the target cell,
wherein the second configuration is configured for the UE by a network side device, and the second configuration comprises at least one of the following:
a cell identifier of at least one first cell in an energy-saving mode;
a wake-up signal characteristic configuration corresponding to each of the first cells;
the target cell is one or more cells in the at least one first cell; or
the wake-up signal characteristic is configured based on a wake-up signal characteristic configuration corresponding to the target cell.

11. The wake-up signal transmission method according to claim 9, wherein the wake-up signal characteristic configuration comprises at least one of the following:
a start location of a wake-up signal sequence;
an end location of a wake-up signal sequence;
a quantity of wake-up signal sequences;
a length of a wake-up signal sequence;
an index or an index range of a wake-up signal sequence;
an index or an index range of a wake-up signal scrambling sequence;
a root sequence of a wake-up signal sequence, or a root sequence list of a wake-up signal sequence; or
a transmit power of a wake-up signal, or a transmit power list of a wake-up signal.

12. The wake-up signal transmission method according to claim 1, wherein the sending, by the UE, the wake-up signal comprises:
sending, by the UE, the wake-up signal on a target resource,
wherein the target resource indicates the target cell, and the target resource comprises at least one of the following:
a time domain resource; or
a frequency domain resource.

13. The wake-up signal transmission method according to claim 1, wherein the wake-up signal carries a cell identifier of the target cell.

14. A wake-up signal transmission method, comprising:
receiving, by a network side device from a UE, a wake-up signal associated with a target cell; and
waking up the target cell when a cell corresponding to the network side device comprises the target cell.

15. The wake-up signal transmission method according to claim 14, wherein the method further comprises:
configuring, by the network side device, a first configuration for the UE,
wherein the first configuration comprises a cell configuration of at least one of first cells, and a cell configuration of each of the first cells comprises at least one of the following:
a cell identifier of the first cell; or
cell information of a second cell associated with the first cell.

16. The wake-up signal transmission method according to claim 15, wherein the cell information of the second cell comprises at least one of the following:
a cell identifier of the second cell; or
a reference signal measurement threshold of the second cell.

17. The wake-up signal transmission method according to claim 14, wherein the wake-up signal comprises a wake-up signal characteristic, wherein the wake-up signal characteristic indicates the target cell.

18. The wake-up signal transmission method according to claim 14, further comprising:
configuring, by the network side device, a second configuration for the UE,
wherein the second configuration comprises at least one of the following:
a cell identifier of at least one first cell in an energy-saving mode;
a wake-up signal characteristic configuration corresponding to each of the first cells;
the target cell is one or more cells in the at least one first cell; or
the wake-up signal characteristic is configured based on a wake-up signal characteristic configuration corresponding to the target cell.

19. The wake-up signal transmission method according to claim 18, wherein the wake-up signal characteristic configuration comprises at least one of the following:
a start location of a wake-up signal sequence;
an end location of a wake-up signal sequence;
a quantity of wake-up signal sequences;
a length of a wake-up signal sequence;
an index or an index range of a wake-up signal sequence;
an index or an index range of a wake-up signal scrambling sequence;
a root sequence of a wake-up signal sequence, or a root sequence list of a wake-up signal sequence; or
a transmit power of a wake-up signal, or a transmit power list of a wake-up signal.

20. A User Equipment (UE), comprising a processor and a memory storing instructions, wherein the instructions, when executed by the processor, cause the processor to perform operations comprising:
obtaining a wake-up signal associated with a target cell; and
sending the wake-up signal.
